(19) United States
(12) Patent Application Publication
(10) Pub. No.: US 2015/0217347 A1
(43) Pub. Date: Aug. 6, 2015

(54) OPERATION OF LANDFILL SITES

(71) Applicant: C.P.S. Environmental Services Limited, Nottingham (GB)

(72) Inventor: Paul Mullins, Nottingham (GB)

(73) Assignee: C.P.S. Environmental Services Limited, Nottingham (GB)

(21) Appl. No.: 14/426,005

(22) PCT Filed: Sep. 2, 2013
(86) PCT No.: PCT/GB2013/052292

§ 371 Date: Mar. 4, 2015

(30) Foreign Application Priority Data
Sep. 4, 2012 (GB) 1215755.8
Sep. 29, 2012 (GB) 1217497.5

(51) Int. Cl. B09B 5/00

(52) U.S. Cl. CPC B09B 5/00

(57) ABSTRACT

A landfill 24 has an impermeable liner 26 at its base and sides, and is capped at 28 by a multi-layer cap. The body of waste material 46 within the landfill 24 will undergo degradation. One byproduct will be leachate. Sediment 37 will develop at the bottom of the landfill 24 in the absence of any intervention. Extraction wells 38 extend from the surface (above the cap 28) down to the bottom of the landfill 24. A pump 54 allows leachate to be drawn from the waste material 46, through the extraction well 38. Leachate is extracted at a rate sufficient to create turbulence within the body of waste material 46. The turbulence serves to entrain sediment in the leachate for extraction of the entrained sediment with the leachate.

The present invention relates to improvements in or relating to operation of landfill sites.

Landfill sites have been in widespread use for many years, for disposal of a wide range of waste material, such as household waste. In one regime of landfill site management, the landfill is lined before filling begins, and is capped when the site is full. This leaves a fully encapsulated body of waste material which begins to degrade. The degradation results in the release of gases, which can be tapped from the landfill, for power generation. As degradation occurs, liquid (called leachate) will collect at the bottom of the landfill, and the top of the landfill will tend to become very dry. The top of the landfill will typically be too dry for further degradation, and may represent a fire hazard. The bottom of the landfill will typically be too wet for further degradation, and may contain high concentrations of toxic substances. An intermediate level may exist, between the dry and wet levels, in which the waste material is sufficiently damp or moist for degradation to occur.

It is desirable to manage the landfill to encourage degradation to occur. To this end, previous proposals have suggested circulation of leachate from the bottom to the top of the landfill. Nevertheless, conventionally managed landfill sites remain potentially hazardous (for fire or for leakage of toxic materials) for long periods of time, perhaps 50 years or more. Landfill operators retain liability during this long period, known as the liability retention period.

Examples of the present invention provide a method of operating a landfill site containing a body of waste material which degrades to create leachate, in which leachate is extracted from the body of waste material, the leachate being extracted at a rate sufficient to create turbulence within the body of waste material, the turbulence serving to entrain sediment in the leachate for extraction of the entrained sediment with the leachate.

The rate of leachate extraction may be changed according to a cycle of relatively high rate periods and relatively low rate periods. There may be no leachate extraction occurring during relatively low rate periods. In relatively high rate periods, leachate may be extracted at a volume rate of at least 3m3/hr.

Leachate may be extracted through a pipe, at a velocity sufficient to retain sediment entrained in the leachate. The velocity may be at least 0.6 m/s, such as 1 m/s.

The level of leachate in the landfill may be monitored, a relatively high rate period being initiated when the level of leachate has increased to reach a predetermined threshold level. The predetermined threshold level may be selectable. The predetermined threshold level may be selected in accordance with parameters measured from the body of waste material and/or the leachate.

The rate sufficient to create turbulence may be selectable from a range. The rate sufficient to create turbulence may be selected in accordance with parameters measured from the body of waste material and/or the leachate.

The step of extracting leachate to create turbulence may be initially preceded by a step of extracting leachate for reintroduction to the body of waste material in an upper region thereof, to dampen the upper region.

The rate of increase of the leachate level in the body of waste material may be monitored, and when the rate exceeds a threshold level, leachate extraction may become substantially continuous.

Extracted leachate may be provided to a settlement tank to allow entrained sediment to settle out of the leachate.

In this aspect of the invention, the leachate extracted from the body of waste material may be reintroduced in accordance with the following aspect of the invention.

In another aspect, examples of the present invention provide a method of operating a landfill site containing a body of waste material which degrades to create leachate, in which leachate is extracted from the body of waste material and is reintroduced to the body by providing a hydraulic head for the leachate.

The hydraulic head may be provided by pumping leachate to a vertical pin well or nozzle through which the leachate is reintroduced.

The hydraulic head may be selected in accordance with parameters measured from the body of material. The hydraulic head may be at least 2m and may be up to 20m. The leachate may be reintroduced in an upper region of the body of waste material.

In this aspect of the invention, the leachate may be extracted in accordance with the first aspect of the invention.

In another aspect, examples of the present invention provide a method of operating a landfill site containing a body of waste material which degrades to create leachate, in which leachate is extracted from the body of waste material through a pipe, the leachate being extracted at a sufficient velocity within the pipe to retain the sediment substantially all entrained in the leachate.

The velocity of leachate within the pipe may be at least 0.6 m/s, such as 1 m/s.

Examples of the present invention will now be described in more detail, by way of example only, and with reference to the accompanying drawings, in which:

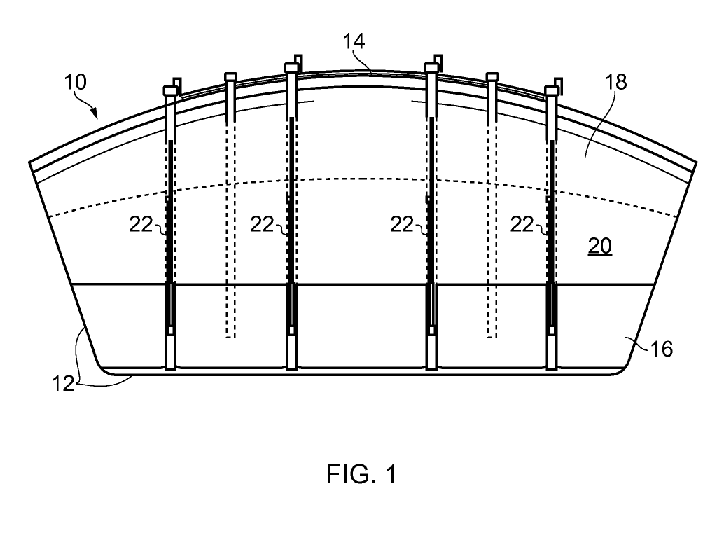

FIG. 1 is a simple schematic, vertical section through a conventional landfill;

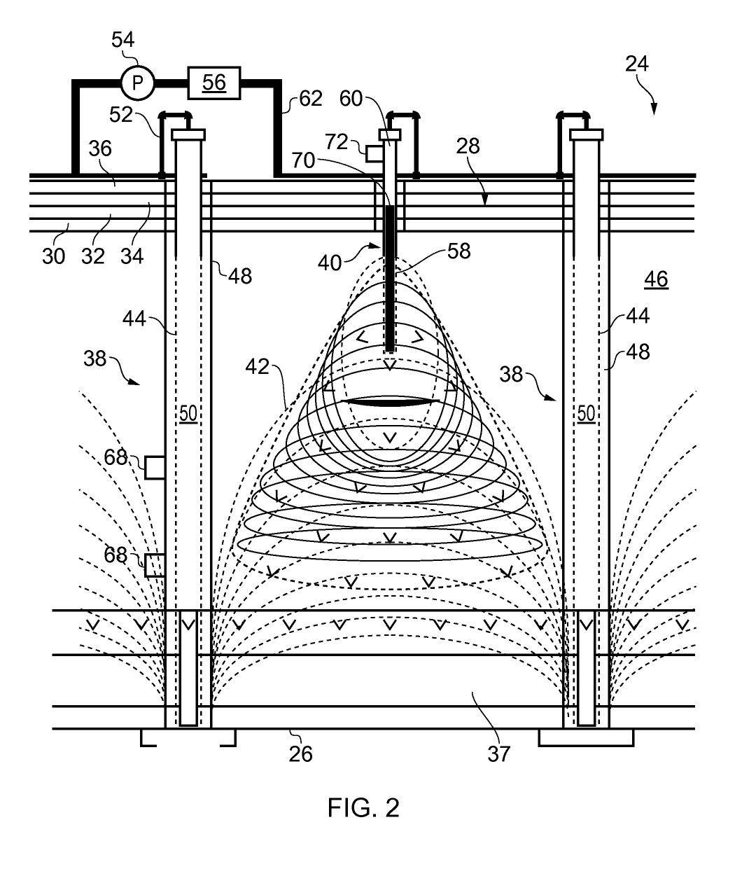

FIG. 2 is a schematic diagram of an arrangement for use in accordance with the present invention;

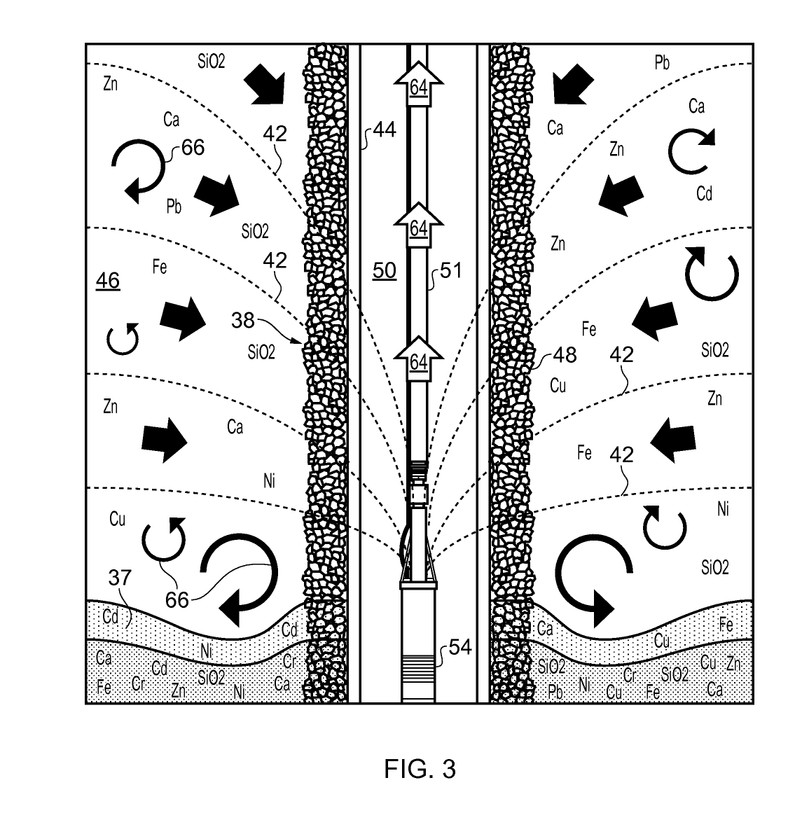

FIG. 3 illustrates part of the arrangement of FIG. 2, in more detail, during use; and

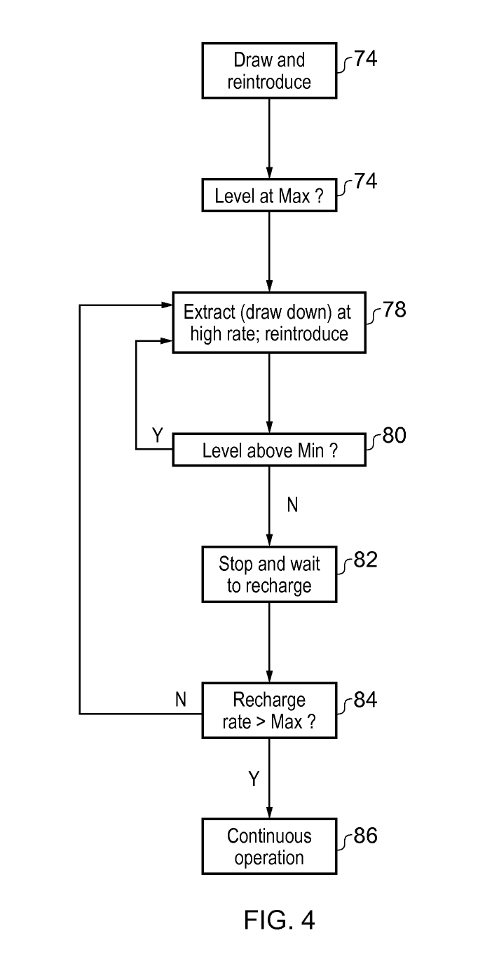

FIG. 4 is a simple flow diagram of a method for using the present invention.

### BACKGROUND

FIG. 1 illustrates a typical landfill 10 managed by a conventional regime. The landfill 10 may have a depth of 50m or more, and may extend over an area of between 10 and 100 hectares. The lower boundaries 12 of the landfill 10 are lined with an impermeable liner material to prevent leakage. While the landfill 10 is open for use, waste material of many different sorts is introduced from above. This may be household waste, for example. When the landfill 10 is full, it is capped by a cap 14. This is intended to seal the landfill 10, particularly against leakage of pollutants. The body of waste material within the landfill 10 will then begin to degrade. Degradation may be aerobic or anaerobic, or either at different locations or different times. One byproduct will be leachate. Leachate is liquid which drains from the degrading waste material, and may contain dissolved and/or suspended material, according to the content of the landfill. The dissolved or suspended material may be toxic, such as particles of heavy metal. Without intervention the leachate will travel down to form a layer 16 of saturated waste material at the bottom of the landfill 10. A dry upper layer 18 is left at the top of the landfill 10. Neither the saturated layer 16, nor the upper layer 18 is able to degrade, being too wet and too dry, respectively. An intermediate moist layer 20 exists between the layers 16, 18, in which the moisture levels are suitable for further degradation. This is known as the active area or active region, and is the primary source of landfill gas (LFG) which can be extracted for energy generation. Extraction wells 22 may be used to extract leachate from the saturated layer 16, for reintroduction at the top of the landfill 10, in an attempt to provide better conditions for degradation of the waste material, thereby increasing the size of the active area.

Extraction and Injection Structures

FIG. 2 shows part of a landfill 24 managed in accordance with the present invention. The landfill 24 has an impermeable liner 26 at its base and sides (not shown), and is capped at 28 by a multi-layer cap, including a barrier layer 30, a porous drainage layer 32 above the barrier layer to allow rainwater or groundwater to drain away, a protection layer 34 for protection of the barrier layer 30 from above, and a topsoil layer 36, primarily for aesthetic reasons.

The body of waste material 46 within the landfill 24 will undergo degradation. One byproduct will be leachate which travels down to form a layer of saturated waste material at the bottom of the landfill 24. Over time, layers of sediment 37 will develop at the bottom of the landfill 24 in the absence of any intervention. The sediment 37 will be formed of heavy components of the leachate, such as heavy metals and other toxic materials.

The cap 28 is penetrated at an array of positions by extraction wells 38, two of which are visible in FIG. 2. The cap 28 is also penetrated by injection wells 40, only one of which is visible in FIG. 2. The injection wells 40 are interspersed between the extraction wells 38. The manner in which the extraction wells 38 and injection wells 40 are operated in accordance with the invention, causes them to influence a region 42 indicated in FIG. 2, as will be described.

Extraction points for LFG will also be provided, allowing for power generation from the LFG.

Extraction Well

Extraction wells 38 can be seen in FIG. 2, and the lower end of an extraction well 38 can be seen in more detail in FIG. 3.

The extraction well 38 is in the form of an outer pipe 44 extending from the surface (above the cap 28), down to the bottom of the landfill 24, immediately above the liner 26. The length of the pipe 44 below the cap 28, that is the length of the pipe 44 within the body of waste material 46, is perforated and is installed within an annular sleeve 48 of gravel or other aggregate. This allows the bore 50 of the pipe 44 to be in fluid communication with the waste material 46, through the perforations of the pipe 44 and through the gravel sleeve 48.

An inner pipe 51 is located axially along the outer pipe 44. The inner pipe 51 is unperforated. The upper end of the inner pipe 51 is connected with pipe work 52 (indicated schematically), at the surface. The pipe 51 is connected to a pump 54. The pump 54 may be at the surface (as shown in FIG. 2), or at the bottom of the inner pipe 51 (as shown in FIG. 3). When operating, the pump 54 is able to draw leachate into the pipe 44, as will be described. The leachate is drawn from the waste material 46. The leachate leaves the pipe 44 through the pipe 51 and the pipe work 52, to a settlement tank 56, allowing any sediment to be deposited in the settlement tank 56. Sediment is able to settle out in the tank 56.

In one example, the pump 54 is at the bottom of the inner pipe 51 (FIG. 3) and is a helical pump containing a helix rotating at a constant speed to push the column of leachate up the inner pipe 51. Thus, the helical pump acts in the manner of an Archimedean screw. Other types of pump can be used, but we have found that the choice of a helical pump is advantageous in creating a substantially constant pumped pressure and thus, a substantially constant flow in the pipe 51. Further discussion of issues relating to the pumped flow are set out below.

In this example the pump 54 is located within the bore 50 of the pipe 44 to draw leachate from the bore 50 and deliver it into the pipe 51, through which the leachate travels to the surface.

Injection Well

The injection well 40 may be called a vertical pin well and is in the form of a pipe 58 extending from the surface (above the cap 28), down into an upper region of the waste material 46. The lower part of the pipe 58 (below the cap 28) is perforated. This allows the bore 60 of the pipe 58 to be in fluid communication with the waste material 46, through the perforations of the pipe 58.

The upper end of the pipe 58 is connected with pipe work 62, through which leachate can be drawn from the settlement tank 56, as will be described. Leachate can be reintroduced into the waste material 46, down the pipe 58 and through the perforations of the pipe 58.

Drawdown

The extraction wells 38 can be used to extract leachate from the waste material 46, in the manner which can now be described. This process is known as “drawdown”,

During drawdown, the pump 54 is used to draw leachate through the gravel sleeve 48 into the pipe 44, particularly at and near the bottom end of the pipe 44. In this manner, leachate is extracted from the body of waste material 46. In this example, leachate is extracted from the body of waste material at a rate sufficient to create turbulence within the body of waste material. This is illustrated in FIG. 3 in which a first set of arrows 64 indicate leachate flowing up the pipe 51, being driven by the pump 54. In one example, the pump 54 is sufficiently powerful to draw at least 3m3/hour from the landfill. This minimum volume has been found sufficient to create turbulence within the body of waste material 46, illustrated by the arrows 66. We have found that when this minimum volume rate is achieved, the resulting turbulence indicated by the arrow 66 serves to entrain sediment 37 in the leachate. This causes the sediment 37 to be drawn into the pipe 44 with the leachate. The sediment is thus pumped up through the pipe 44 to the settlement tank 56.

We have also found that it is desirable to maintain a minimum flow velocity in the pipe 51, particularly in the vertical run to the surface.

A flow velocity of at least 0.6 m/s, such as 1 m/s is expected to minimize any build up of sediment within the pipe 51 (particularly at joints or other discontinuities). Smooth walled pipe work further assists in keeping the pipe 51 and the pipe work 54 clear of tuberculation or other forms of obstruction. Examples of suitable materials for forming smooth walled pipes 51 and pipe work 52 include medium and high density polyethylene (MDPE/HPDE).

The following are examples of flow velocities which can be achieved with various combinations of volume rates of extraction and pipe diameters. In this table, DN32 indicates a nominal pipe diameter of 32 mm. Flow rates (m/s) are then:

| | Flow rates | | | | | |
|---|---|---|---|---|---|---|
| Pump Diam- | 1.5 | 3.0 | 4.5 | 6.0 | 7.5 | 9.0 |
| eter (mm) | m³/hr | m³/hr | m³/hr | m³/hr | m³/hr | m³/hr |
| DN32 | 0.518 | 1.036 | 1.554 | 2.072 | 2.590 | 3.108 |
| DN50 | 0.212 | 0.424 | 0.637 | 0.849 | 1.061 | 1.273 |
| DN63 | 0.134 | 0.267 | 0.401 | 0.535 | 0.668 | 0.802 |
| DN90 | 0.065 | 0.131 | 0.196 | 0.262 | 0.327 | 0.393 |
| DN110 | 0.044 | 0.088 | 0.132 | 0.175 | 0.219 | 0.263 |

It can be seen that the use of a smaller pipe size results in a higher flow velocity. However, reducing the pipe size will also increase the artificial head created within the pipe, primarily by frictional losses and therefore, different choices can be made for the values of these various parameters, according to the particular circumstances of the implementation. In the table, italics are used to indicate the combinations which achieve the desired minimum flow velocity of 0.6 m/s.

We have found that by using a sufficient volume rate to create turbulence, even the sediment of heavy materials can be cleaned from the waste material 46 and drawn into the pipe 44. Once in the pipe 51, we have also found that by ensuring the minimum flow velocity, the entrained sediment will be extracted with the leachate.

We have also found that the effectiveness of the leachate in entraining sediment can be improved by allowing the depth of leachate to increase to a depth which is higher than would conventionally be acceptable within a landfill (typically around 1 m), such as a depth between 5m and 10m. Once this increased depth has built up, the leachate is drawn down at the flow velocities discussed above. The combined effect of the turbulence created by the flow velocity, and the large volume of leachate which is drawn off in this way (arising from the initial depth of the leachate), results in sediment being purged effectively from the landfill 24.

In order to facilitate this effect, sensors 68 are provided in association with the extraction well 38, to sense the depth of leachate within the waste material 46. FIG. 2 illustrates two sensors at respective positions, one above the other, allowing two depths of leachate to be sensed. Other sensor arrangements could be used to measure the depth of leachate. These may allow various different depths to be measured.

The sensors 68 are used to control a cycle of drawdown, which includes periods in which the rate of leachate extraction is relatively high, and periods in which the rate of leachate extraction is relatively low. In one example, no leachate extraction occurs during relatively low rate periods. In a relatively high rate period, leachate is extracted at the volumes and velocities dictated by the pump 54, as noted above. In this example, when the depth of leachate has increased to reach an upper threshold level, drawdown is initiated, for reasons explained above, causing sediment to be flushed from the waste material 46. Drawdown will continue in this manner and at the relatively high rate until the depth of leachate has reduced to a lower threshold level, when the relatively low rate (which may be zero) of leachate extraction begins. This allows leachate levels to build up again within the waste material 46, until the upper threshold level is again reached and drawdown is once again initiated.

The upper and lower threshold levels may be preset, such as by installation of sensors 68 at appropriate heights within the material 46. Alternatively, sensor arrangements which can sense various current levels of leachate will allow the predetermined threshold levels to be selectable, for example in accordance with parameters measured from the body of waste material and/or the leachate, either within the landfill 24, or within the settlement tank 56, or within the pipe work 52. This allows the extraction regime to be adjusted as the conditions change in the landfill. We have found that by changing the leachate height at which drawdown begins, the size of the region 42 influenced by the process can be changed. This region 42 is generally conical and can be called the “cone of influence”.

Similarly, the pump 54 may be designed to operate at a single speed within the range discussed above, or maybe a variable speed pump, allowing the rate to be selectable from a range (while still sufficient to create turbulence and to maintain entrainment). The selection may be made in accordance with parameters measured from the body of waste material and/or the leachate, either within the landfill 24, or within the settlement tank 56, or within the pipe work 52. Again, this allows the extraction regime to be adjusted as the conditions change in the landfill, and is found to affect the size of the cone of influence.

Injection

The injection well 40 is used as a nozzle for reintroducing leachate back into the waste material 46. The leachate is reintroduced in an upper region of the landfill 26, where the waste material 46 can be expected to be relatively dry. The injection well 40 is in the form of a vertical pipe 58, as has been described. Accordingly, leachate can be introduced into the top end of the pipe 58, to flow down through the pipe and back into the waste material 46. If leachate is introduced into the top of the pipe 58 at a rate greater than it can leave the pipe 58, the pipe 58 will fill up with leachate (as indicated by the level 70 of leachate in the pipe 58), thus creating a hydraulic head of leachate within the pipe 58. This has the effect of driving the leachate material into the waste material 46.

Sensor arrangements 72 may be incorporated in the injection well 40 to allow the level of leachate within the pipe 58 to be measured, thus measuring the hydraulic head driving leachate into the waste material 46. This allows the hydraulic head to be selected, for example in accordance with a parameter measured from the body of material 46. In one example, the hydraulic head used to drive leachate into the waste material 46 is at least 2m and may be up to 20m or more. The hydraulic head used in any particular situation may be chosen with reference to the depth of the landfill 24.

The introduction of leachate is also influenced by operation of the extraction wells, as will be described.

Operating Sequence

Various steps for operation of the extraction well 38 and injection well 40 have been described above. In one example, additional steps are used and it is therefore appropriate to describe this example further, with reference to FIG. 4.

When management of the capped landfill 26 is to commence, an initial step 74 consists of drawing leachate from the waste material 46, through the extraction well 38 at a relatively low rate (not sufficient to cause turbulence and entrainment of sediment). The leachate is then reintroduced at the top of the waste material 46, through the injection well 40. This initial step 74 causes the upper layers of waste material 46 to be dampened, thus allowing some degradation to begin. This will result in additional leachate being created and moving down through the landfill 26. This continues until step 76 determines that the maximum level of leachate has been achieved, as sensed by the sensors 68. Step 78 then commences extraction at a rate sufficient to create turbulence, as described above, so that sediment in the leachate is entrained and extracted with the leachate. Eventually, sufficient leachate will be drawn down to reach the minimum leachate level, detected at step 80. Drawdown of leachate is then stopped, allowing leachate levels to rise (step 82). The speed of this rise is monitored. Initially, the speed at which leachate levels rise (the well recharge rate) will be relatively slow, but will tend to increase as the higher levels of the landfill become damp and thus begin degradation, generating additional leachate.

If the well recharge rate is found to be slow (step 84), the method reverts to step 78 for extraction of further leachate at a rate sufficient to create turbulence and entrainment of sediment. Eventually, a condition is reached at which the well recharge rate has become faster than a maximum rate (assessed at step 84). This corresponds with substantially the whole body of the waste material 46 being suitably moist for degradation and accordingly, the method then enters a steady-state (step 86) in which substantially continuous extraction and reintroduction of leachate takes place.

Concluding Remarks

We have found that by using the apparatus described above, to manage the landfill 26 in accordance with the methods described, various advantages can be achieved, as follows.

First, using an extraction rate sufficient to create turbulence allows sediment to be flushed from the waste material 46, removed from the landfill 26, and captured in the settlement tank 56. This avoids the buildup of unacceptably high levels of toxic material at the bottom of the landfill 26, reducing risks associated with leakage from the site.

Second, we have found that using a high extraction rate creates hydraulic pressure differences within the waste material 46, causing leachate to be pulled down through the landfill 26. This helps avoid leachate becoming trapped at higher positions in the waste material 46, a condition sometimes called “perching”.

Third, we have found that perching is further reduced by the use of leachate injection driven by a hydraulic head.

Fourth, we have found that the combined effect of leachate injection from the injection well 40, and fast extraction of leachate from the extraction well 38 creates leachate movement throughout a large cone of influence 42, and generally much larger than would be expected in conventional landfill management regimes.

Many different types of pump, sensor, pipe and other components can be used.

The overall result of all of these effects is to create an environment in which substantially the whole contents of the landfill can be maintained at moisture levels appropriate for degradation, thus reducing fire risks from dry material, speeding up the production of waste gases, which increases the amount of power generation which can be achieved and increases the rate of settlement and stabilization of the waste.

Many variations and modifications can be made to the apparatus described above, without departing from the scope of the present invention. In particular, many different materials can be used for the various components. Many different arrangements of extraction wells and injection wells can be envisaged and in particular, the ratio of the number of extraction wells and the number of injection wells can be varied.

1. A method of operating a landfill site containing a body of waste material which degrades to create leachate, in which leachate is extracted from the body of waste material, the leachate being extracted at a rate sufficient to create turbulence within the body of waste material, the turbulence serving to entrain sediment in the leachate for extraction of the entrained sediment with the leachate.

2. A method according to claim 1, wherein the rate of leachate extraction is changed according to a cycle of relatively high rate periods and relatively low rate periods.

3. A method according to claim 2, wherein substantially no leachate extraction occurs during relatively low rate periods.

4. A method according to claim 2, wherein in relatively high rate periods, leachate is extracted at a volume rate of at least 3m3/hr.

5. A method according to claim 1, wherein leachate is extracted through a pipe, at a velocity sufficient to retain sediment entrained in the leachate.

6. A method according to claim 5, wherein the velocity is at least 0.6 m/s, such as 1 m/s.

7. A method according to claim 1, wherein the level of leachate in the landfill is monitored, a relatively high rate period being initiated when the level of leachate has increased to reach a predetermined threshold level.

8. A method according to claim 7, wherein the predetermined threshold level is selectable.

9. A method according to claim 8, wherein the predetermined threshold level is selected in accordance with parameters measured from the body of waste material and/or the leachate.

10. A method according to claim 1, wherein the rate sufficient to create turbulence is selectable from a range.

11. A method according to claim 1, wherein the rate sufficient to create turbulence is selected in accordance with parameters measured from the body of waste material and/or the leachate.

12. A method according to claim 1, wherein the step of extracting leachate to create turbulence is initially preceded by a step of extracting leachate for reintroduction to the body of waste material in an upper region thereof, to dampen the upper region.

13. A method according to claim 1, wherein the rate of increase of the leachate level in the body of waste material is monitored, and when the rate exceeds a threshold level, leachate extraction becomes substantially continuous.

14. A method according to claim 1, wherein extracted leachate is provided to a settlement tank to allow entrained sediment to settle out of the leachate.

15. A method according to claim 1, wherein the leachate extracted from the body of waste material is reintroduced by providing a hydraulic head for the leachate.

16. A method of operating a landfill site containing a body of waste material which degrades to create leachate, in which leachate is extracted from the body of waste material and is reintroduced to the body by providing a hydraulic head for the leachate.

17. (canceled)

18. (canceled)

19. (canceled)

20. (canceled)

21. A method of operating a landfill site containing a body of waste material which degrades to create leachate, in which leachate is extracted from the body of waste material through a pipe, the leachate being extracted at a sufficient velocity within the pipe to retain the sediment substantially all entrained in the leachate.

22. (canceled)

23. (canceled)

24. (canceled)
